(19) United States
(12) Patent Application Publication
(10) Pub. No.: US 2006/0151434 A1
(43) Pub. Date: Jul. 13, 2006

(54) Selective surface texturing through the use of random application of thixotropic etching agents

(75) Inventors: John Gilbert Deem, Chandler, AZ (US); David P. Laube, Mesa, AZ (US)

Correspondence Address: Ira Lee Zebrak;The BOC Group, Inc., Legal Services-IP, 575 Mountain Ave., Murray Hill, NJ, 07974, US

(73) Assignee: The BOC Group, Inc.

(21) Appl. No.: 11/031,379

(22) Filed: Jan. 7, 2005

(51) Int. Cl. B44C 1/22; C09K 13/00; B22D 7/00

(52) U.S. Cl. 216/83; 252/79.1; 216/100; 428/544; 118/715

(57) ABSTRACT

An improved process for predictably treating a substrate surface is provided comprising the use of a pre-selected thixotropic etchants to achieve a superior and predetermined substrate surface.

### FIELD OF THE INVENTION

The present invention is directed generally to the field of surface treatments. More particularly, the present invention is directed to the field of providing agents to a surface to increase surface roughness to improve the adhesion of subsequent surface coatings.

### BACKGROUND

There are several accepted treatments currently used to alter the surface characteristics of metal substrates to improve the adhesion of coatings delivered to the treated substrate surface by techniques including plating, sputtering, spray coating, etc. Such surface alterations for improving adhesion often entail increasing the surface “roughness” (or lessening the “smoothness”) to increase surface area, which increases binding sites for layers to adhere to the substrate surface. Such surface treatment methods include chemical etching, both wet and dry grit blasting, twin wire arc spray, metal spray, and plasma spray. Most of these methods share inherent failings. In the case of abrasive blasting, there can be significant unwanted substrate deformation along with residual embedded grit remaining in the substrate surface. Depending upon the substrate use, such embedded impurities or material deformation can compromise the adhesion properties of subsequent coatings and depositions.

Molten metal sprays, such as Twin Wire Arc Spray (TWAS) also can result in undesirable surfaces, as the substrate surface is often prepared for the spray through a grit blasting process. TWAS properties that maximize adhesion of subsequent depositions also tend to be porous. However, the more porous coatings have less adhesion to the substrate than exhibited by a dense spray.

### SUMMARY OF THE INVENTION

In one embodiment, the present invention is directed to aqua regia-containing, ferric chloride-containing, hydrogen peroxide/HCl-containing, and potassium hydroxide-containing thixotropic compounds further comprising an amount of fumed silica. In a further embodiment, fumed silica is added to the above-noted solutions in an amount of from about 0.1 to about 0.2 g/ml of solution to achieve the desired thixotropic characteristics.

In a further embodiment, the present invention is directed to a method for treating and predictably altering a substrate surface by providing and exposing a substrate surface to a provided thixotropic etching compound, and exposing the substrate surface to the compound for a pre-selected time before removing the thixotropic compound from the substrate surface.

In a still further embodiment, the present invention is directed to a method for treating and predictably altering a substrate surface by providing to a substrate surface a thixotropic etching compound selected from the group consisting of aqua regia-containing, ferric chloride-containing, hydrogen peroxide/HCl-containing, and potassium hydroxide-containing solutions, each solution treated with an amount of fumed silica. The etching compound is applied to the substrate surface, left for a pre-determined time to achieve a desired surface effect, and is then removed from the surface.

In a further embodiment, the substrate surfaces treated by the thixotropic agents of the present invention are preferably aluminum, stainless steel and titanium-containing substrates.

### BRIEF DESCRIPTION OF THE DRAWINGS

FIG. 1 is a flow chart outlining one preferred method of the present invention.

FIG. 2 is an enlarged photograph of a substrate surface treated by grit blasting.

FIG. 3 is an enlarged photograph of a substrate surface treated by TWAS.

FIG. 4 is an enlarged photograph of a substrate surface treated according to one method of the present invention.

### DETAILED DESCRIPTION

The present invention is directed to processes for improving substrate surface characteristics using a chemical etchant to selectively attack the substrate surface, creating a surface roughness similar to abrasive blasting, but without embedding grit particulate in the substrate surface. For sputter deposition and chemical vapor deposition (CVD) shields, the areas requiring texturing are limited to surfaces that receive the deposits. To prevent unwanted etching, this requires masking all surfaces not requiring texturing. To make any chemical surface texturing techniques commercially viable, a method to apply etchants to the deposition areas with minimum masking is required.

The present invention is directed to the use of a thixotropic etchant paste having a pre-selected viscosity to allow the etchant to be applied to the desired areas of the substrate surface, and remain thereon for a pre-determined time without running, dripping, or sagging. “Thixotropic” as generally defined refers to the property of materials to appear solid or gel-like when left standing alone, but which liquefy or flow like a liquid when a sideways force is applied, such as a vibrational force, and re-solidify when the force ceases. The thixotropic etchant pastes of the present invention are preferably prepared using a fumed silica material combined with the chemical etchant in a ratio that provides a desired viscosity. According to the present invention, by selecting the appropriate substrate, and substrate surface, a desired surface roughness having a desired surface morphology is obtainable through the use of a pre-selected etchant paste application regimen.

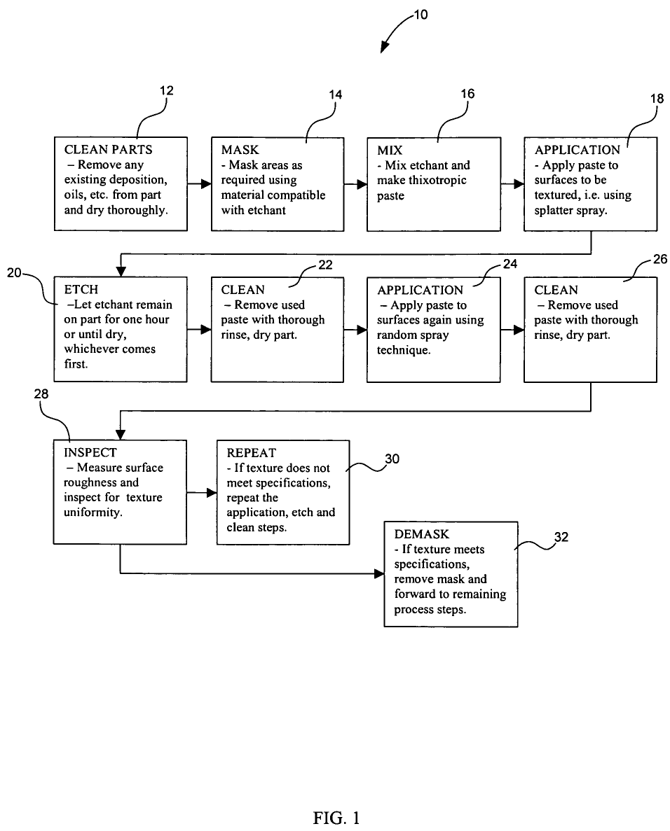

According to one embodiment of the present invention, as shown in the flowchart presented as FIG. 1, in step one 12 of a preferred process 10, clean and dry parts are provided, with the parts next being masked 14 with a material that will be compatible with a selected etchant (optional). In the next step 16, an etchant is selected and mixed to make a thixotropic paste that is then applied 18 (for example via splatter spray) to part surfaces to be textured. In the next step shown 20, the etchant remains in contact with the part surface until dry, followed by 22 rinsing the part clean and drying. A second application of thixotropic paste is applied to the part surfaces 24 using a random spray technique, followed by cleaning 26 to remove used paste. The part is then inspected 28, to measure surface “roughness” and uniformity. The process is repeated 30 if the texture does not meet specifications upon inspection 28. If the part passes inspection, the part is demasked 32 and proceeds on for further processing as desired.

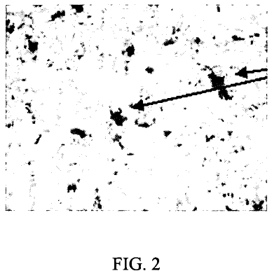

FIG. 2 is an enlarged backscattered electron image of an aluminum surface that has been grit blasted with 36-24 grit aluminum oxide (alumina) using a siphon blaster set between about 40 and about 80 psi. The presence of embedded alumina particles from the grit blasting procedure are clearly visible. Embedded grit from such grit blasting methods can create disbond sites for subsequent deposits as well as potential arcing sites in PVD chambers. Further, unwanted, embedded grit can be a source of particle generation in vacuum deposition chambers.

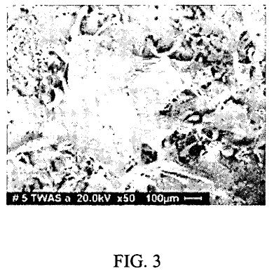

FIG. 3 is an enlarged backscattered electron image of a TWAS-treated stainless steel substrate surface. TWAS processing typically comprises two wire feeds, in this case aluminum, that are connected to opposite poles of a DC voltage source. As the wire is fed to a nozzle, it is melted by an arc between the wires and is subsequently atomized and propelled towards the substrate surface by the compressed air flow. The metal cools upon contact with the substrate and creates the desired surface texture by adhering thereto. The deposited molten spray on the substrate surface to enhance the surface texture, or roughness, is evident. Therefore, TWAS coatings increase the surface roughness of shields by applying molten metal spray to theoretically form desired surface “roughness”. Such coatings increase the amount of sputter deposits that can be applied by increasing the area for mechanical bonding and absorption or reduction of film stress as film thickness increases. Arc spray coatings, too, are prone to disbond, either by cohesive or adhesive failure. The present invention eliminates the potential for such coating failures since no permanent coatings are being applied to smooth or treat surfaces. By contrast, the thixotropic etchants of the present invention are applied in paste-like form, and at desired viscosities to substrate surfaces for pre-determined and controlled durations, and are later completely removed from the substrate surfaces to which they were applied.

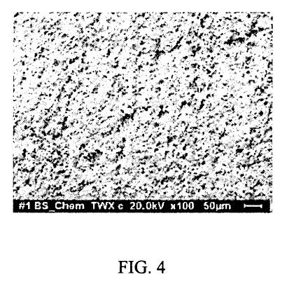

FIG. 4 is an enlarged, backscattered electron image of the improved chemically textured substrate surface effected according to one embodiment of the present invention, at ambient temperatures and pressures of approximately one hour each with three treatments total. The substrate was 6061 aluminum alloy, with a thixotropic aqua regia-based etchant prepared as specified below.

The thixotropic etchants of the present invention are preferably deposited to the substrate parts to be treated, according to methods known to deposit ultra-thin uniform layers. The thicknesses of such deposited thixotropic etchant layers are preferably from about 1 mm to about 5 mm, and are more preferably from about 1 mm to about 2 mm. It is understood by those skilled in the field, that any means used to successfully deliver a viscous coating at such thicknesses would be useful with respect to the present invention. Further, is it understood that all processing is preferably accomplished at ambient temperature and pressure to simplify processing costs (no additional equipment or considerations being required), and that actual drying times can vary with temperature and humidity.

The preferred thixotropic etchant selected depends upon the part substrate material. For example, a ferric chloride-based thixotropic etchant (82.5% by weight FeCl₃, 10% by volume HCl) was preferably used to selectively etch surfaces for stainless steel and aluminum-based substrates. Aqua regia thixotropic etchants (25% by volume HNO₃, 75% by volume HCl) were used to successfully etch aluminum-based substrates. Further, hydrogen peroxide/HCl thixotropic mixtures are also thought to be effective according to the present invention, for etching metal substrates, including titanium. Still further, potassium hydroxide (KOH/H₂O)-based thixotropic etchants, according to the present invention, are thought to be useful for etching aluminum-based substrates.

The present invention contemplates treating the above-identified chemical etchants into “stable” thixotropic pastes by providing to the mixture an amount of fumed silica (SiO₂) such as Cab-O-Sil® M-5 (Sold commercially as Cob-O-Sil®, Cabot Corp, Tuscola, Ill.) in an amount of from about 0.1 to about 0.2 grams/ml.

The processes contemplated by the present invention would be particularly useful and advantageous over conventional techniques used in the semiconductor field to make metallic shields, such as, for example, aluminum shields in a copper deposition chamber. The viscosity of the thixotropic etchants of the present invention allow for the etchant to be applied to the substrate area to be treated for as long a time as is needed before further treatment, and to effect the desired surface treatment. While thixotropic pastes of any useful viscosity able to maintain position on a substrate surface are contemplated, the preferred thixotropic pastes of the present invention more preferably have a viscosity of from about 100,000 cp to about 500,000 cp at 25° C., and most preferably from about 150,000 cp to about to about 300,000 cp at 25° C. After the paste is removed and the part cleaned of remaining etchant, a substrate surface having a desired surface feature (smoothness or roughness) is achieved. This is in strong contrast to conventional etchants which are more fluid rather than paste-like and which are difficult to control, and, in fact, require significant masking of the substrate surfaces so as to not etch unwanted regions. Reducing or obviating the need to mask at all, makes the processes of the present invention particularly desirable, as the elimination of such time-consuming masking steps greatly reduces overall processing costs, and enhances overall product quality. The thixotropic agents of the present invention may be applied where they are needed on the part substrate surfaces, remain in place for as long as desired, and then are removed. The chemical surface texturing (e.g. smoothing or roughening) of the present invention eliminates the potential for applied coating failure, as various coating and masking steps are eliminated from the surface treatment process.

Further, according to the processes of the present invention, the thixotropic etchants for substrate surface texturing can be pre-selected to provide unique surface morphologies by designing etchant properties to chemically attack substrate surface grain boundaries at predictable rates.

The methods and compounds of the present invention have been primarily directed to the treatment of certain metal surfaces with etchants of a particular consistency to remain in contact with the surface to which they have been applied for a specified duration. The etchants have chemical properties designed to interact, and react with the substrate surface in a pre-determined manner to achieve a new substrate surface having desired characteristics. The etchants are understood to be washed from the substrate surface once the surface has been altered as desired. The ability to apply an etchant in a thick, thixotropic state at a desired viscosity and thickness that will not “run”, drip, or move from the point of application is highly desirable and commercially advantageous from a standpoint of removing processing steps, and reducing clean up and safety concerns.

It is understood that the present invention also contemplates the manufacture and use of thixotropic agents to alter surfaces of non-metal substrates including natural and synthetic rubbers, thermoform and thermoplastic compounds, etc.

While the invention has been described in detail with reference to specific embodiments thereof, it will be apparent to one skilled in the art that various changes and modifications can be made, and equivalents employed without departing from the scope of the claims.

We claim:

1. A thixotropic compound made from a composition selected from the group consisting of: aqua regia-containing, ferric chloride-containing ; hydrogen peroxide/HCl-containing, and potassium hydroxide-containing solutions, said solutions treated with an amount of fumed silica.

2. The thixotropic compound of claim 1 wherein the fumed silica is provided to the solutions in an amount of from about 0.1 to about 0.2 g/ml of solution.

3. The thixotropic compound of claim 1, wherein the compound has a viscosity of from about 100,000 cp to about 500,000 cp at 25° C.

4. A method for treating a substrate surface comprising the steps of:
providing a substrate having a surface;
providing a thixotropic etching compound;
applying the thixotropic etching compound to the substrate surface and exposing the surface to the compound for a pre-selected time; and
removing the thixotropic compound from the substrate surface.

5. A method for treating a substrate surface comprising the steps of:
providing a substrate having a surface;
providing a thixotropic etching compound, said compound comprising a solution selected from the group consisting of: aqua regia-containing, ferric chloride-containing; hydrogen peroxide/HCl-containing, and potassium hydroxide-containing solutions, said solution treated with an amount of fumed silica;
applying the thixotropic etching compound to the substrate surface and exposing the surface to the compound for a pre-selected time; and
removing the thixotropic compound from the substrate surface.

6. The method of claim 4, wherein the substrate is selected from the group consisting of aluminum, stainless steel and titanium.

7. The method of claim 4, wherein the thixotropic compound comprises about 25% HNO₃, about 75% HCl and about 0.2 g/ml fumed silica.

8. The method of claim 4, wherein the thixotropic compound comprises about 82.5% FeCl₃ by weight, 10% HCl by volume, and about 0.2 g/ml fumed silica.

9. The method of claim 4, wherein the thixotropic compound has a viscosity of from about 100,000 cp to about 500,000 cp at 25° C.

10. The method of claim 4, wherein the thixotropic compound is applied to the substrate surface by an application method selected from the group consisting of: splatter spray, and hand application techniques.

11. The method of claim 4, wherein the thixotropic compound is removed from the substrate surface by rinsing the substrate surface with de-ionized water.

12. A method of predictably increasing the roughness of a substrate surface comprising the steps of:
providing a substrate having a surface;
providing a thixotropic etching compound, said compound comprising a solution selected from the group consisting of: aqua regia-containing, ferric chloride-containing, hydrogen peroxide/HCl-containing, and potassium hydroxide-containing solutions, said solutions treated with an amount of fumed silica;
applying the thixotropic etching compound to the substrate surface and exposing the substrate surface to the compound for a pre-selected time; and
removing the thixotropic compound from the substrate surface.

13. The method of claim 12, wherein the substrate is made from a metal selected from the group consisting of: aluminum, stainless steel, and titanium.

14. The method of claim 12, wherein the substrate is a part selected from the group consisting of: sputter deposition, and chemical vapor deposition shields.

15. A metal part having a surface treated with a thixotropic etching agent selected from the group consisting of: aqua regia-containing, ferric chloride-containing, hydrogen peroxide/HCl-containing, and potassium hydroxide-containing solutions, said solutions treated with an amount of fumed silica.

16. The metal part of claim 15, wherein the fumed silica is provided in an amount of from about 0.1 to about 0.2 g/ml of solution.

17. The metal part of claim 14, wherein the part is selected from the group consisting of: sputter deposition shields, and chemical vapor deposition shields.
